(19) United States
(12) Patent Application Publication
(10) Pub. No.: US 2016/0121806 A1
(43) Pub. Date: May 5, 2016

(54) METHOD FOR ADJUSTING OUTPUT VIDEO OF REAR CAMERA FOR VEHICLES

(71) Applicant: Hyundai Mobis Co., Ltd., Seoul (KR)

(72) Inventor: Seong soo LEE, Yongin-si (KR)

(21) Appl. No.: 14/925,320

(22) Filed: Oct. 28, 2015

(30) Foreign Application Priority Data
Oct. 29, 2014 (KR) 10-2014-0148539

(51) Int. Cl. B60R 11/04; G06T 3/60; B60R 1/00; G06T 7/00

(52) U.S. Cl. CPC B60R 11/04; G06T 7/0018; G06T 3/60; B60R 1/00; B60R 2300/402; G06T 2207/10016; G06T 2207/30264; B60R 2300/802

(57) ABSTRACT

A video adjusting method of a rear camera for a vehicle, including: detecting a predetermined pattern through an intrinsic parameter of a rear camera and geometry information; estimating a posture of the rear camera currently provided in the vehicle, from a pattern reference coordinate system through the predetermined pattern detected by the pattern detecting step; obtaining the homography corresponding to an angle error of the installed camera which is checked by the camera posture estimating step; and calibrating the video photographed by the installed camera based on a posture of a camera mounted in accordance with the design criteria using the homography obtained by the homography obtaining step.

### CROSS-REFERENCE TO RELATED APPLICATION

The present application claims priority from and the benefit of Korean Patent Application No. 10-2014-0148539, filed on Oct. 29, 2014, which is hereby incorporated by reference for all purposes as if fully set forth herein.

### BACKGROUND

1. Field

Exemplary embodiments relate to a video adjusting method of a rear camera for a vehicle. More particularly, exemplary embodiments relate to a video adjusting method of a rear camera for a vehicle which adjusts a photographed video by an angle error of an installed rear camera based on video information photographed by a rear camera, and outputs the video to prevent an accident.

2. Discussion of the Background

A rear camera installed in a vehicle allows a rear side of the vehicle to be visible to a driver through a monitor while the driver drives the vehicle in reverse so as to park the vehicle. The driver is then able to safely drive or park the vehicle while moving in reverse.

Generally, the rear camera is buried in or attached onto a garnish, a license plate, a trunk, an emblem, a spoiler, or a bumper and the rear camera is generally fixedly mounted in one rear side of the vehicle such that a lens is exposed.

A video, which is photographed by the rear camera, is output to a display unit of an audio and video system (AV system) of a driver's seat so that the driver may check the situation of a rear side that is displayed on the display unit at the time of driving the vehicle in reverse so as to park the vehicle.

A rear camera disclosed in Korean Unexamined Patent Application Publication No. 10-2003-0017772 (Mar. 4, 2003) is provided in various positions of the vehicle to provide video information of the rear side of the vehicle. However, an optical axis of such a rear camera is off-center due to change of a position of the rear camera so that video information at an exact point cannot be provided.

In a rear camera disclosed in Korean Unexamined Patent Application Publication No. 10-2013-0005159 (Jan. 15, 2013), when a position of the rear camera is changed, a photographing position of the rear camera is changed through an actuator so that an optical axis of the rear camera is adjusted by utilizing video information captured by the rear camera to the maximum, thereby solving the problem of the above-described related art.

However, according to the second related art, there is a problem in that in order to change the photographing position of the rear camera, a separate actuator needs to be provided, so that the number of components is increased while also increasing man hours of assembly, which may cause an increase in production costs.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a video adjusting method of a rear camera for a vehicle which adjusts a photographed video by an angle error of a currently-installed rear camera based on video information photographed by a rear camera without having a separate actuator, and outputs the video to prevent an accident.

Additional aspects will be set forth in the detailed description which follows, and, in part, will be apparent from the disclosure, or may be learned by practice of the inventive concept.

An exemplary embodiment discloses a video adjusting method of a rear camera for a vehicle including: detecting a predetermined pattern through an intrinsic parameter of a rear camera and geometry information; estimating a posture of the rear camera (hereinafter, simply referred to as “an installed camera”) currently provided in the vehicle, from a pattern reference coordinate system through the detected predetermined pattern; obtaining homography corresponding to an angle error of the installed camera that is checked by the estimated camera posture; and calibrating the video photographed by the installed camera based on a posture of a camera (hereinafter, simply referred to as a “camera mounted by design criteria”) mounted in accordance with the design criteria using the obtained homography.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1A and FIG. 1B are views schematically illustrating an installed state of a rear camera for a vehicle according to the related art and an image photographed therefrom, and a backward direction of the vehicle.

FIG. 2 is a control flow chart illustrating an exemplary embodiment of a video adjusting method of a rear camera for a vehicle according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of elements may be exaggerated for clarity and descriptive purposes. Also, like reference numerals denote like elements.

When an element is referred to as being “on,” “connected to,” or “coupled to” another element or layer, it may be directly on, connected to, or coupled to the other element or intervening elements may be present. When, however, an element is referred to as being “directly on,” “directly connected to,” or “directly coupled to” another element, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, these elements should not be limited by these terms. These terms are used to distinguish one element from another element. Thus, a first element discussed below could be termed a second element without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, an exemplary embodiment of a video adjusting method of a rear camera for a vehicle according to the present invention will be described in detail with reference to accompanying drawings.

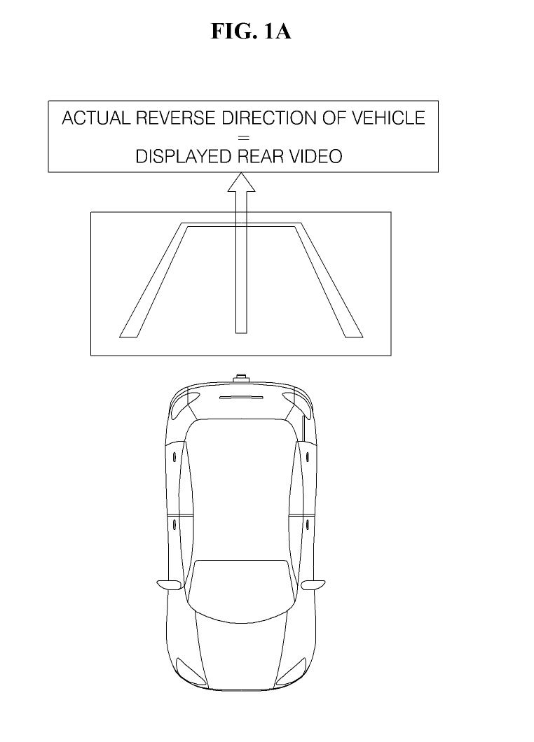

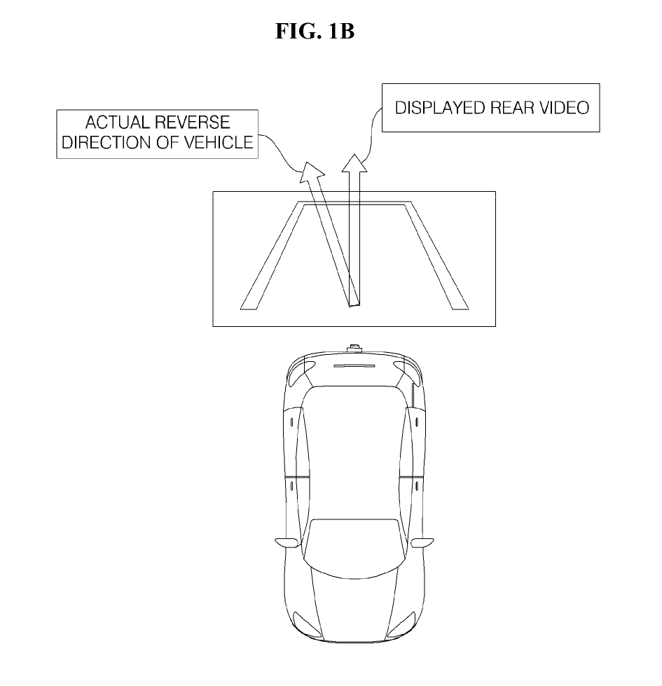

FIGS. 1A and 1B are views schematically illustrating an installed state of a rear camera for a vehicle according to the related art and an image photographed therefrom and a backward direction of the vehicle.

As illustrated in FIG. 1A, when the rear camera is provided at a rear side of a vehicle body in accordance with design criteria, an actual backward direction of the vehicle and a driving direction in the displayed rear image are the same. In contrast, as illustrated in FIG. 1B, when the rear camera is off-center by a predetermined angle from the design criteria, the actual backward direction of the vehicle and the driving direction in the displayed rear image are different from each other, so that an accident may be caused while parking the vehicle.

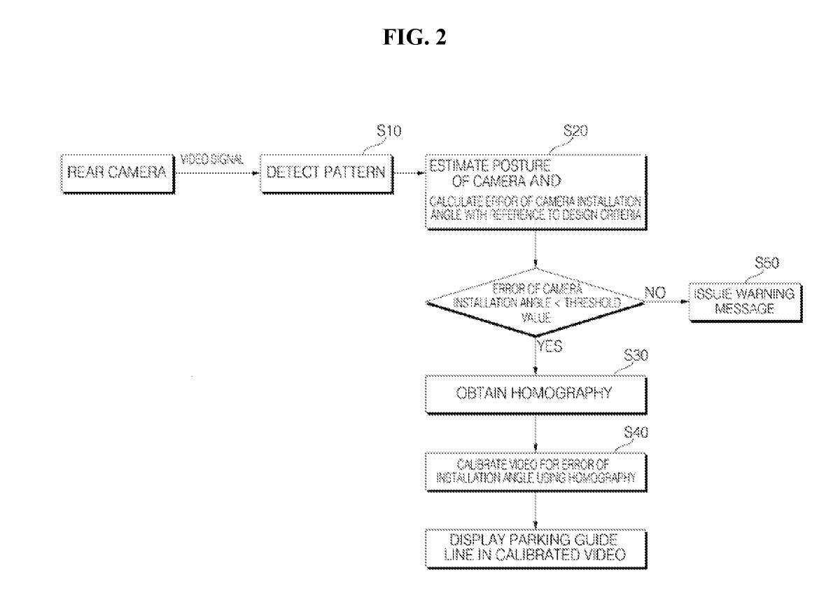

FIG. 2 is a control flow chart illustrating an exemplary embodiment of a video adjusting method of a rear camera for a vehicle according to an exemplary embodiment of the present invention.

An exemplary embodiment of the video adjusting method of a rear camera for a vehicle according to the present invention includes, as illustrated in FIG. 2, a pattern detecting step S10 of detecting a predetermined pattern through an intrinsic parameter of a rear camera and geometry information, a camera posture estimating step S20 of estimating a posture of the rear camera (hereinafter, simply referred to as “an installed camera”) currently provided in the vehicle, from a pattern reference coordinate system through the predetermined pattern detected by the pattern detecting step S10, a homography obtaining step S30 of obtaining homography corresponding to an angle error of the installed camera, which is checked by the camera posture estimating step S20, and a video calibrating step S40 of calibrating the video photographed by the installed camera based on a posture of a camera (hereinafter, simply referred to as a “camera mounted by design criteria”) mounted in accordance with the design criteria using the homography obtained by the homography obtaining step S30.

Generally, in order to calibrate an image of the camera, an intrinsic parameter and an extrinsic parameter need to be obtained, and the pattern detecting step S10, which detects the predetermined pattern, is a step of obtaining the extrinsic parameter.

The extrinsic parameter refers to information indicating to what degree the camera is spaced apart from an original point in an actual world and how much the camera rotates, but the extrinsic parameter is not determined when the camera is manufactured.

In contrast, the intrinsic parameter refers to a structural error of the camera caused by lens distortion or internal information of the camera caused by changes in a focal distance caused by zoom-in or zoom-out.

Here, the pattern detecting step S10 may be a step of detecting the predetermined pattern based on an intrinsic parameter element and geometry information of the camera having the same data, without distinguishing between the type of currently-installed camera and the type of camera mounted according to the design criteria.

More specifically, the camera may represent the image by a predetermined shape of a pattern in accordance with the data, and set a pattern reference coordinate system through the pattern. The pattern reference coordinate system set as described above becomes a reference for estimating the posture of the installed camera and the posture of a camera mounted by the design criteria.

The camera posture estimating step S20 calculates a posture of the installed camera from the pattern reference coordinate system based on the posture of the camera mounted by the design criteria (hereinafter, referred to as a “first calculation”) and calculates the posture of the installed camera using a pattern detected from a camera (hereinafter, simply referred to as a “camera mounted in the process line”) mounted in a process line (hereinafter, referred to as a “second calculation”).

In the meantime, the homography may be image information obtained by rotating the image by the posture (hereinafter, referred to as a “second posture”) of the camera calculated by the first calculation from the posture (hereinafter, referred to as a “first posture”) of the camera calculated by the second calculation.

The homography becomes a basis for calibrating the rear video, which may be erroneously photographed due to a physically off-centered angle of the installed camera. More specifically, when it is assumed that a Z-axis value of a three-dimensional coordinate of an actual world is zero, a two-dimensional plane having an XY coordinate is provided, and the two-dimensional plane may be a two-dimensional video photographed by the camera. Feature points of the two-dimensional video may be changed as if the feature points are seen from another angle, which are called homography.

The first posture and the second posture may include a position (X, Y, and Z coordinates) of the camera obtained from the pattern reference coordinate system, and an angle (e.g., roll, pitch, and yaw). That is, the first posture and the second posture refer to postures including an omnidirectional angle to photograph the rear video by the installed camera.

When the camera mounted in the process line has an error which is equal to or greater than a predetermined reference angle, as compared with a camera mounted by design criteria as a result of calculating the first posture and the second posture, the camera posture estimating step S20 cannot be performed. When the error of the installed camera is equal to or greater than the predetermined reference angle as compared with the camera mounted by design criteria, an image quality of the rear video, which is calibrated using the homography is reduced, or the video may be processed as a distorted video, which may present inaccurate input information to the driver. The reduced image quality or the inaccurate input information may cause the driver to have an accident. In this case, instead of performing the video calibrating step S40, a predetermined warning unit is used to issue a warning to the user (a warning step S50), such that the user may directly observe the environment with the naked eye to attempt a vehicle parking operation in reverse without depending on the video displayed from the installed camera.

When the driver receives a predetermined warning by the warning step S50, the driver immediately tries to remount the camera and ignores the displayed video to try to safely park the vehicle while moving backward.

The predetermined reference angle may be set so as not to exceed 5 degrees in any direction with respect to the pattern reference coordinate system.

The homography may be obtained by an operation which calculates a matrix R, which rotates the camera to the normally installed camera angle direction using a difference between angle information of the installed camera and angle information of the camera mounted in the process line.

More specifically, the following Equation is an equation which calibrates a video using the homography.

P′=KRK⁻¹P Equation 1:

Here, P indicates a video coordinate of the camera mounted in the process line, P′ indicates a video coordinate in a direction of the camera mounted by design criteria, K indicates the intrinsic parameter of the camera. KRK⁻¹ refers to the homography and is a 3×3 matrix R, as described above.

Specifically, similarly to the present invention, when only one stationary rear camera is provided, the three-dimensional coordinates may not be calculated. However, as described above, when the intrinsic parameter is accurately obtained in accordance with the data of the camera, the homography may be obtained through Equation 1.

More specifically, even though Equation 1 does not represent exact three-dimensional information, there may be a method which assumes that a field of view seen by the rear camera is a plane (which is referred to as a ground plane) and estimates coordinates of the ground plane of a target detected from the image. This may be realized if there is projective transformation between the image plane and the ground plane. Such homography is referred to as a plane to plane homography.

A method which obtains generally used homography is a direct linear transformation (DLT) algorithm. When the DLT method is used, if four or more corresponding point pairs between the two planes are given, the homography is obtained.

According to an exemplary embodiment of the video adjusting method of a rear camera for a vehicle, it is possible to accurately obtain the intrinsic parameter in accordance with data of the camera. Further, since it is possible to exactly know the pattern reference coordinate system, the DLT method is very efficient and the video may be simply calibrated using the homography through the above-mentioned simple equation.

According to the video adjusting method of a rear camera for a vehicle according to the present invention configured as described above, when the installed camera is off-center so as not to exceed the predetermined reference angle to photograph an incorrect rear video, the incorrect rear video is calibrated to be displayed for the driver. Therefore, the driver may park the car in a reverse direction while ensuring a trustworthy rear video. Further, there is no need to provide a separate actuator which physically rotates the installed camera to calibrate the video, which may result in further providing convenience for the user.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A video adjusting method of a rear camera for a vehicle, comprising:
detecting a predetermined pattern using an intrinsic parameter of a rear camera and geometry information;
estimating a posture of an installed rear camera currently provided in the vehicle, from a pattern reference coordinate system through the predetermined pattern detected by the pattern detecting step;
obtaining homography corresponding to an angle error of the installed rear camera which is checked by the camera posture estimating step; and
calibrating video photographed by the installed rear camera based on a posture of a another camera mounted in accordance with design criteria using the homography obtained by the homography obtaining step.

2. The method of claim 1, wherein:
in the camera posture estimating step, a posture of the installed rear camera is calculated in a first calculation from the pattern reference coordinate system based on a posture of the camera mounted by design criteria; and
the posture of the installed rear camera is calculated in a second calculation using the pattern detected from the camera which is mounted in the process line.

3. The method of claim 2, wherein the homography is image information obtained by rotating the image by a second posture of the camera calculated by the first calculation from a first posture of the camera calculated by the second calculation.

4. The method of claim 3, wherein the first posture and the second posture include a position (X, Y, and Z coordinates) of the camera obtained from the pattern reference coordinate system and an angle (roll, pitch, and yaw).

5. The method of claim 2, further comprising:
when the error of the camera mounted in the process line is equal to or greater than a predetermined reference angle as compared with the camera mounted by design criteria, without performing the camera posture estimating step, a warning step of issuing a warning to a user.

6. The method of claim 5, wherein the setting angle is set so as not to exceed 5 degrees in any direction with respect to the pattern reference coordinate system.

7. The method of claim 2, wherein the homography is obtained by an operation which calculates a matrix R which rotates the camera to the normally installed camera angle direction using a difference between angle information of the installed camera and angle information of the camera mounted in the process line.
